(19) United States
(12) Patent Application Publication
(10) Pub. No.: US 2026/0170126 A1
(43) Pub. Date: Jun. 18, 2026

(54) DETERMINING CONFIGURATION PARAMETERS FOR AN EMULATOR TO MIMIC MALWARE TYPES TO TRAIN MALWARE CLASSIFIERS

(71) Applicant: INTERNATIONAL BUSINESS MACHINES CORPORATION, ARMONK, NY (US)

(72) Inventors: Dionysios Diamantopoulos, Zurich (CH); Roman Alexander Pletka, Uster (CH); Yves Alexandre Beraldo dos Santos, Marana, AZ (US); Andrew D. Walls, SAN JOSE, CA (US); Charalampos Pozidis, Thalwil (CH)

(21) Appl. No.: 18/986,691

(22) Filed: Dec. 18, 2024

(51) Int. Cl. G06F 21/55; G06F 21/56

(52) U.S. Cl. CPC G06F 21/552; G06F 21/564

(57) ABSTRACT

Provided are a computer implemented method, system, and computer program product for determining configuration parameters for an emulator to mimic malware types to train malware classifiers. A determination is made as to whether an emulator training classifier classifies emulator training traces, resulting from operations of an emulator implementing configuration parameters, as malicious activity that exceeds a threshold rate of malicious activity. The configuration parameters for a malware type are saved in response to the malicious activity exceeding the threshold rate. An instance of the emulator is deployed to operate with the saved configuration parameters in a system to generate operations to produce classifier training traces to train a malware classifier to recognize malicious activity in the system for the malware type. The malware classifier is deployed in the system to detect and report malicious activity during production operations in the system.

### STATEMENT REGARDING PRIOR DISCLOSURES BY THE INVENTOR OR A JOINT INVENTOR

The following disclosure is submitted under 35 U.S.C. 102(b)(1)(A):

DISCLOSURE: “WannaLaugh: A Configurable Ransomware Emulator”, D. Diamantopoulos et al., SYSTOR '24, Sep. 23-24, 2024, Virtual, Israel, Sep. 16, 2024, 14 pp.

### BACKGROUND OF THE INVENTION

### 1. Field of the Invention

The present invention relates to a computer implemented method, system, and computer program product for determining configuration parameters for an emulator to mimic malware types to train malware classifiers.

### 2. Description of the Related Art

Ransomware is a type of malware that infiltrates a computer system and encrypts user data to then demand payment of money or a ransom to have the data unencrypted. A network intrusion detection system scans traffic on a network to detect malicious traffic containing ransomware. Machine learning based ransomware detection may use low-level memory access patterns at storage devices in a storage controller to detect presence of ransomware accessing the storage devices.

### SUMMARY

Provided are a computer implemented method, system, and computer program product for determining configuration parameters for an emulator to mimic malware types to train malware classifiers. A determination is made as to whether an emulator training classifier classifies emulator training traces, resulting from operations of an emulator implementing configuration parameters, as malicious activity that exceeds a threshold rate of malicious activity. The configuration parameters for a malware type are saved in response to the malicious activity exceeding the threshold rate. An instance of the emulator is deployed to operate with the saved configuration parameters in a system to generate operations to produce classifier training traces to train a malware classifier to recognize malicious activity in the system for the malware type. The malware classifier is deployed in the system to detect and report malicious activity during production operations in the system.

### BRIEF DESCRIPTION OF THE DRAWINGS

FIG. 1 illustrates an embodiment of a computing environment to generate malware classifiers to improve accuracy of classification in a user environment.

FIG. 2 illustrates an embodiment of a training set generated from classifier output to train the malware classifiers.

FIG. 3 illustrates an embodiment of operations to generate configuration parameters for an emulator to mimic operations of malware and benign activity types.

FIGS. 4A and 4B illustrate an embodiment of operations to train malware classifiers from traces resulting from operations produced by the emulator implementing configuration parameters for different malware and benign activity types.

FIG. 5 illustrates a computing environment in which the components of FIG. 1 may be implemented.

### DETAILED DESCRIPTION

Classifier machine learning models may be used to classify an occurrence of a harmful event, e.g., presence of ransomware, from input comprising features of system operations. However, the classifier may produce false positives and false negatives at an unacceptable level. Further, many ransomware classifiers may be trained in an operating environment different from the operating environment in which they are deployed, and thus may not accurately model how ransomware operates in the specific user environment. In addition, even if the same operating environment is used, the aging effects from long-term data storage and use on a storage device can significantly impact the model's accuracy.

Described embodiments provide improvements to computer technology to train malware classifiers to recognize malware versus benign activity in a specific user environment. With described embodiments, classifiers, trained from real malware and real benign activity, are used to generate configuration parameters for an emulator to mimic the workloads of both malware and benign activity types. The emulator is then deployed in the user environment to run the configuration parameters for the malware and benign activity types to generate operations that result in traces of metrics of the operations. These traces are then inputted to the malware classifiers to determine whether classifications are false negatives or false positives. This information on false positives and false negatives is then used to train the malware classifiers based on operations that occur in the user environment. Once the malware classifiers are trained to an acceptable level of accuracy, they may be deployed in the user environment.

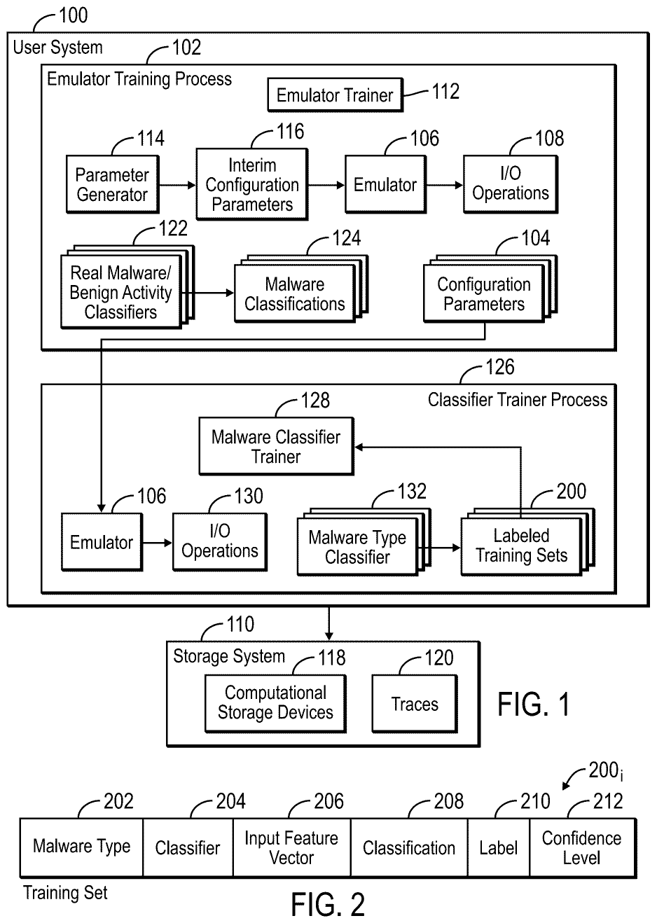

FIG. 1 illustrates an embodiment of a user system 100 having an emulator training process 102 to generate sets of configuration parameters 104 for different malware and benign activity types, such as different types of malware and benign activity workloads, including ransomware, viruses, etc., and different types of benign activity for different benign workload types. Each set of configuration parameters 104 is used to configure an emulator 106 to produce Input/Output (I/O) operations 108 for a specific malware or benign activity type. The configuration parameters 104 may include, without limitation: target directories to which the emulator 106 reads and writes; file ordering operations to select files on which to operate, e.g. random, by file size, by modification time, etc.; filtering options to filter files by file types on which to operate, e.g. avoid logs or system files to not render the system unusable, etc.; encryption algorithm to use to encrypt data, e.g. AES256, CHACHA20, SALSA20, etc.; encryption content methods to select a subset of content in files to encrypt, e.g., first number of bytes, last number of bytes, intermittent encryption, etc.; encryption write method indicating one of overwriting original file, shredding the original file and writing to a new file, and copying the original file to a new file; delay mode indicating delays between file encryption operations; timeout to specify a time limit for the encryption operations; custom file extension for encrypted files; indicating whether to use multiple threads for emulator operations; changing the desktop background; dropping ransom notes to selected folders; exfiltrating data before or after the encryption; using the same or unique encryption key per file or batch of files selected for encryption; and in addition to encrypt the data also encrypt the keys used for encrypting the data. The emulator 106, configured with a particular set of configuration parameters 104, may generate I/O operations 108 toward a storage system 110 of the user system 100, such as read, write, delete, create, modify, and encryption operations.

The emulator training process 102 includes an emulator trainer 112 to manage the emulator training operations. The emulator trainer 112 may call a parameter generator 114 to generate interim configuration parameters 116 to consider for use as the final configuration parameters 104 for malware and benign activity types. The initial interim configuration parameters 116 may initially be set to random values. The parameter generator 114 may utilize an algorithm to generate new interim configuration parameters 116 in each iteration of training operations, including a random walk algorithm, simulated annealing algorithm, greedy genetic algorithm, a Non-Dominated Sorting Genetic Algorithm (NSGA), such as NSGA-II, or other suitable algorithms. In each iteration, the emulator 106 is loaded with the interim configuration parameters 116 to generate I/O operations 108 with respective to the storage system 110.

The storage system 110 includes computational storage devices 118. Upon processing the I/O operations 108, the computational storage devices 118 may produce traces 120 providing metrics on the result of the I/O operations 108 with respect to the computational storage devices 118. The traces 120 may include, without limitation, metrics such as: Shannon entropy of writes; number of reads and writes; read and write throughput; variance of logical block address (LBA) reads and writes; read/write throughput; variance of LBA reads and writes to a master boot record; variance of LBA reads and writes to a boot partition; variance of LBA reads and writes to an operating system partition; variance of LBA reads and writes to a recovery partition; and variance of LBA reads and writes to a data partition. The storage system 110 may aggregate traces across storage devices 118 to return aggregated traces.

In described embodiments, traces are obtained from computational storage devices. However, in additional embodiments, I/O information can be collected at any level of the storage hierarchy. Further, traces can be collected further down in the stack level to collect in-storage IO operations (e.g., extracting I/O features directly from the storage device layer, e.g. from the Flash cells having hardware units calculating those features). Traces can also be extracted from an upper stack, such as at the Operating System kernel space using a device driver (e.g., a Linux® device mapper kernel module). Further, at the operating system level, traces can be extracted from I/O operations at the block level either from the backend device layer (e.g. Linux® Asynchronous IO, Ceph RADOS® (Reliable Autonomic Distributed Object Store), PMDK® (Persistent Memory Development Kit), virtio-blk, etc.) or at the object/file level from the user-application layer (e.g. Ceph® object/file, DPDK (Data Plane Development Kit)). Traces can also be collected from I/O operations from the memory subsystem that typically interacts with the storage subsystem (e.g. through cache, buffering, etc.) and the network when it comes to storage over network (e.g. NVMe® (Nonvolatile Memory Express), NAS (Network Attached Storage), SAN (Storage Area Network)). At the network level, the traces from the I/O operations can be extracted by analyzing the network traffic and filtering the packets corresponding to storage traffic. (Linux is a registered trademark owned by Linus Torvalds; CEPH and RADOS are registered trademarks owned by Red Hat, Inc.; PMDK is a trademark owned by Intel Corporation; NVMe is a registered trademark owned by NVM Express, Inc.)

The emulator training process 102 may include a plurality of real malware/benign activity classifiers 122 pre-trained on the operations of real malware types and benign activity types. The parameters of the real classifiers 122 may be fixed through a hyper-parameter optimization (HPO) at an earlier stage. Each classifier 122 would be trained to classify input traces 120 as a particular malware type or benign activity type or not the malware or benign activity type on which the classifier 122 is trained. The classifiers 122 output malware classifications 124, indicating whether the input traces 120 are the specific malware/benign activity type or not. If the traces 120 result in a classification of a specific malware or benign activity type at a threshold rate, then the current interim configuration parameters 116 loaded in the emulator 106 are saved as final configuration parameters 104 for the specific malware or benign activity type.

In the embodiment of FIG. 1, the emulator training process 102 is implemented in the user system 100 for which the malware classifiers will run. In an alternative, the emulator training process 102 may occur in a developer system or in a cloud system to generate the final configuration parameters 104 for the emulator to load and run. In a further embodiment, the emulator training process 102 may run in a sandbox virtual machine copy of the user system 100 so as not to disrupt production activity at the user system 100.

The emulator 106 and the final configuration parameters 104 are then deployed in the classifier training process 126 in the user system 100. A malware classifier trainer 128 manages the classifier training operations. The emulator 106 runs with the configuration parameters 104 for the malware/benign types to produce I/O operations 130 for time period samples. The I/O operations 130 directed toward the storage system 110 result in traces 120 that are inputted to the malware type classifiers 132 being trained for different malware/benign activity types. The output classification from the malware type classifiers 132 is used to form the labeled training sets 200 for malware types. In certain embodiments, only malware type classifiers 132 are trained.

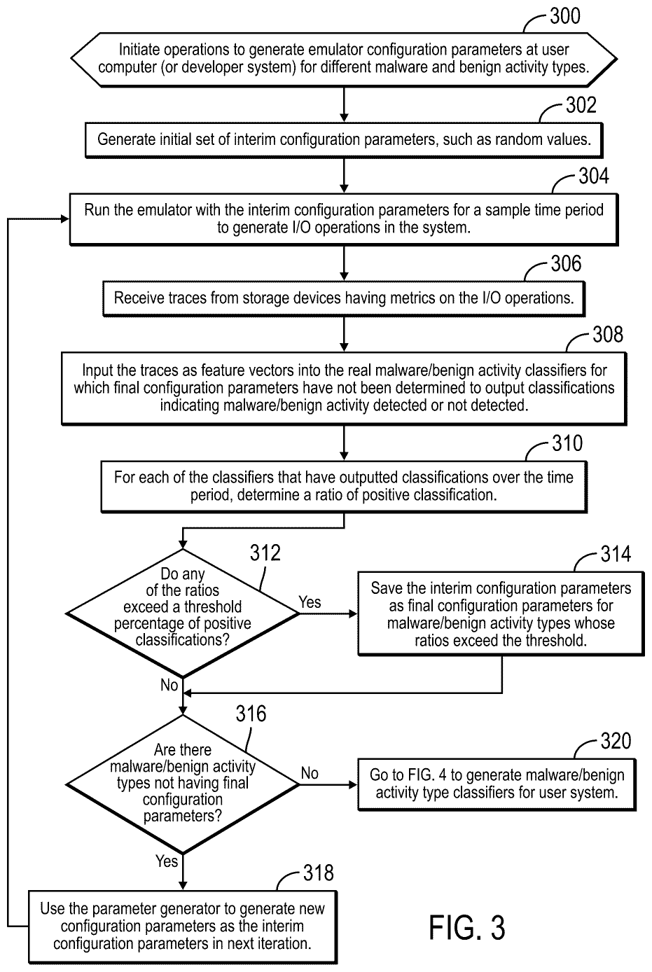

FIG. 2 provides an embodiment of an instance of a labeled training set 200ᵢ, where i denotes the instance of the labeled set. Each labeled training set 200, as shown in FIG. 2, includes a malware type 202 indicating the malware/benign activity type for which the emulator 106 was configured when generating the I/O operations 130; the classifier 204 that produced the output classification 208; an input feature vector 206 of the traces that resulted in the classification 208; a label 210 comprising a ground truth of what the classification should be based on the malware type 202 of the configuration parameters 104 that are currently running; and a confidence level 212 of the classification, indicating a likelihood the output is correct or will be acceptable to the user. For instance, the label 210 for a specific malware type 202 may comprise the malware type 202 that the emulator 106 is emulating with the configuration parameters 104.

The labeled training sets 200 for the different malware type classifiers 132 are generated for windows within a time period during which the emulator 106 runs and generates I/O operations 130. The malware classifier trainer 128 uses the labeled training sets 200 to train the malware type classifiers 132 until they output classifications with an acceptable accuracy level.

The arrows shown in FIG. 1 between the components and objects in the storage controller represent a data flow between the components.

Generally, program modules, such as the program components 102, 106, 112, 114, 122, 126, 128, 132, among others, may comprise routines, programs, objects, components, logic, data structures, and so on that perform particular tasks or implement particular abstract data types. The program components and hardware devices of the system 100 may be implemented in one or more storage systems or computer systems, where if they are implemented in multiple storage systems or computer systems, then the storage systems or computer systems may communicate over a network or a bus.

The program components 102, 106, 112, 114, 122, 126, 128, 132, among others, may be accessed by a processor from memory to execute. Alternatively, some or all of the program components 102, 106, 112, 114, 122, 126, 128, 132, among others, may be implemented in separate hardware devices, such as Application Specific Integrated Circuit (ASIC) hardware devices, Data Processing Units (DPUs), and/or Field Programmable Gate Arrays (FPGAs).

Program components implementing machine learning models, such as program components 122, 132, among others, may be implemented in an Artificial Intelligence (AI) hardware accelerator, such as an FPGA or a graphics processing unit (GPU).

In certain embodiments, program components 114, 122, 132, among others, may use machine learning and deep learning algorithms, such as decision tree learning, association rule learning, neural network, inductive programming logic, support vector machines, Bayesian network, Recurrent Neural Networks (RNN), Feedforward Neural Networks, Convolutional Neural Networks (CNN), Deep Convolutional Neural Networks (DCNNs), Generative Adversarial Network (GAN), etc. For artificial neural network program implementations, the neural network may be trained using backward propagation to adjust weights and biases at nodes in a hidden layer to produce their output based on the received inputs. In backward propagation used by the malware classifier trainer 128 to train a neural network machine learning module, such as the classifiers 132, biases at nodes in the hidden layer are adjusted accordingly to produce the output, such as classification of traces indicating presence of malware and ransomware, with specified confidence levels based on the input parameters. The program components 124, 132, among others, may be trained to produce their output from feedback and their output based on the input. Backward propagation may comprise an algorithm for supervised learning of artificial neural networks using gradient descent. Given an artificial neural network and an error function, the method may use gradient descent to find the parameters (coefficients) for the nodes in a neural network or function that minimizes a cost function measuring the difference or error between actual and predicted values for different parameters. The parameters are continually adjusted during gradient descent to minimize the error.

In backward propagation performed by the trainer 128, used to train a neural network machine learning module, such as the program components 132, margin of error is determined based on a difference of the calculated predictions and user rankings of the output. Biases (parameters) at nodes in the hidden layer are adjusted accordingly to minimize the margin of error of the error function.

In an alternative embodiment, the components 124, 132 may be implemented not as a machine learning module, but implemented using a rules based system to determine the outputs from the inputs, or be, implemented in methods other than neural networks, such as multivariable linear regression models. The components 124, 132 may be implemented using an unsupervised machine learning module.

The functions described as performed by the program components 102, 106, 112, 114, 122, 126, 128, 132, among others, may be implemented as program code in fewer program modules than shown or implemented as program code throughout a greater number of program modules than shown.

The user system 100 may comprise a server or production site of an enterprise to which the malware type classifiers 132 are deployed to detect malware during production operations and take protective action upon detecting malware, such as alerting an administrator, quarantining further I/O operations from the application whose I/O operations result in a classification of malware by one of the classifiers 132, and triggering recovery mechanisms of affected volumes, e.g. by recovering volumes' snapshots that are stored based on the backup strategy of a user/enterprise.

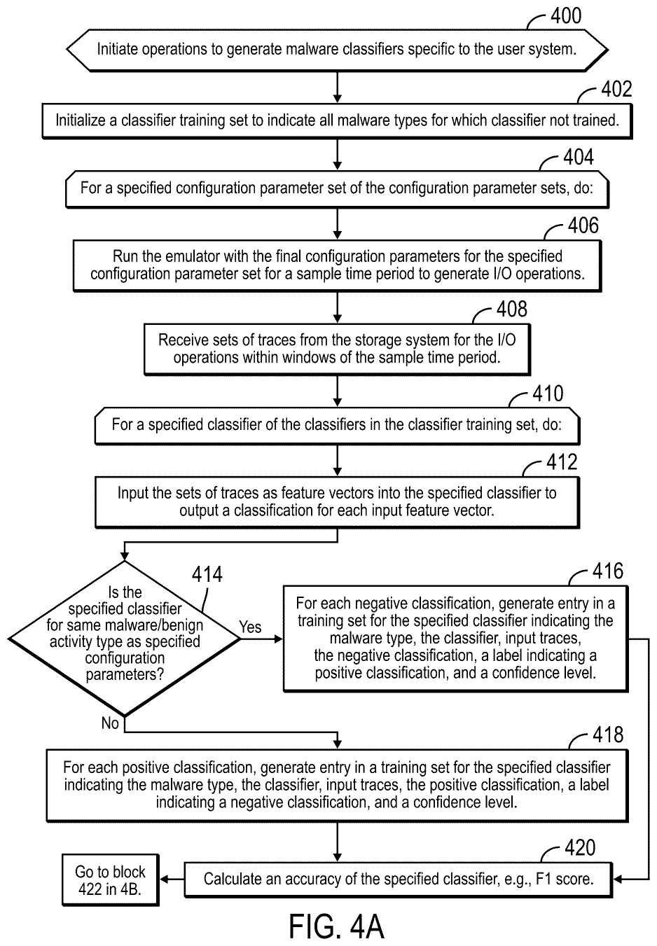

FIG. 3 illustrates an embodiment of operations performed by the emulator training process 102 to generate final configuration parameters for different malware/benign activity types. Upon initiating (at block 300) operations to generate final configuration parameters, such as final configuration parameters 104, the parameters generator 114 initially generates (at block 302) interim configuration parameters 116, such as random values. The emulator 106 is loaded (at block 304) with the interim configuration parameters 116 and runs for a sample time period generating I/O operations 108, which may be done in the user system 100 or a developer system. The I/O operations 108 are performed with respect to a storage system 110 and may involve reads, writes, deletes, file creation, encryption, compression, etc. The emulator trainer 112 receives (at block 306) traces 120 comprising metrics produced by the storage system 110 based on the I/O operations 108. The traces 120 are inputted (at block 308) into the real malware/benign activity classifiers 122 to output classifications 124 indicating malware/benign activity detected or not detected. The emulator trainer may determine (at block 310), for each of the real malware/benign activity classifiers that have outputted classifications over the time period, a ratio of positive classification to overall classifications. This indicates an accuracy of the interim configuration parameters to control the emulator to mimic malware/benign activity types as determined by classifiers trained on real ransomware and benign activity workloads.

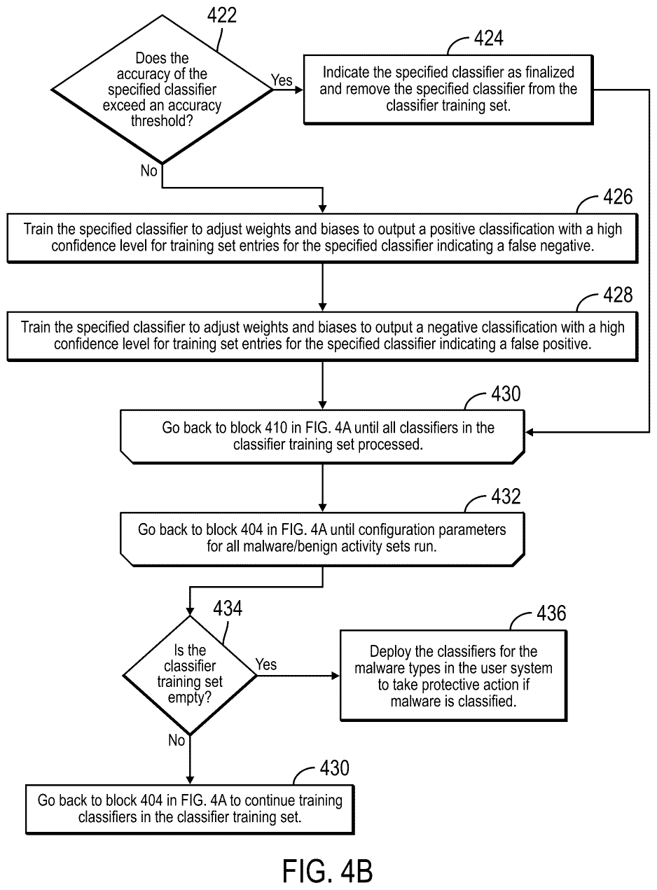

If (at block 312) any of the ratios of positive classifications exceed a threshold percentage of positive classifications, then the interim configuration parameters producing those ratios exceeding the threshold are saved (at block 314) as final configuration parameters. From block 314 or the NO branch of block 312, if (at block 316) there any malware/benign activity types not having final configuration parameters saved, then the parameter generator generates (at block 318) new configuration parameters as the interim configuration parameters to use in the next iteration of testing the new interim configuration parameters from the operations at block 304. If (at block 316) all malware/benign activity types have final configuration parameters, then control proceeds to FIGS. 4A and 4B to generate malware/benign activity type classifiers to deploy in the user system.

With the embodiment of FIG. 3, configuration parameters are generated that can control the emulator to accurately mimic each of the malware/benign activity types being considered. Classifiers trained on actual malware and benign activity workloads are used to determine when the configuration parameters, when loaded into an emulator, produce workloads that mimic the target workload at an acceptable rate.

FIGS. 4A and 4B illustrate an embodiment of operations performed in the classifier trainer process 126 to train malware classifiers that can accurately detect malware and distinguish from benign activity in the user system at an acceptable rate. With respect to FIG. 4A, upon initiating (at block 400) operations to generate the malware type classifiers 132 specific to the user system 100, the malware classifier trainer 128 initializes (at block 402) a classifier training set to indicate all the malware classifiers being trained. A loop of operations is performed at blocks 404 through 432 for a specified configuration parameter set of each of the final configuration parameters 104 for the malware/benign activity types. At block 406, the emulator 106 runs with the specified configuration parameters for a sample time period to generate I/O operations 130. Sets of traces 120 are received (at block 408) from the storage system 110 for windows within the sample time period.

A loop of operations is then performed at blocks 410 through 430 for a specified classifier of each of the classifiers in the classifier training set. The malware classifier trainer 128 inputs (at block 412) the sets of traces as feature vectors into the specified classifier to output a classification for each input feature vector. If (at block 414) the specified classifier is for the same malware type as the specified configuration parameters, which may be fore malware or benign activity types, then the classification should have been positive and a negative classification would be a false negative. In such case, for each negative classification (false negative), the malware classifier trainer generates (at block 416) a training entry 200; in a training set for the specified classifier indicating the malware type 202, the classifier 204, the input feature vector 206 of traces, the output classification 208 of negative, a label 210 indicating a positive classification, and a confidence level. The label 210 indicates the positive classification because the emulator is presumed to mimic the malware type.

If (at block 414) the specified classifier is for a different malware type from that for the specified configuration parameters, then the classification should have been negative and a positive classification would be a false positive. In such case, for each positive classification (false positive) , the malware classifier trainer generates (at block 418) a training entry 200; in a training set for the specified classifier indicating the malware type 202, the classifier 204, the input feature vector 206 of traces, the output classification 208 of positive, a label 210 indicating a negative classification, and a confidence level.

From block 416 or 418, an accuracy of the specified classifier is calculated (at block 420), which may comprise an F1 score, or other suitable accuracy measurement, which may be based on the number of samples for the specified classifier, false positives, and false negatives.

Control proceeds to block 422 in FIG. 4B where the malware classifier trainer determines whether the accuracy of the specified classifier exceeds an accuracy threshold, or until a specified number of iterations is reached. The algorithm may be defined with a predefined iteration number, e.g., 1000 seps, which is deterministic in terms of execution time and because of difficulty in estimating a fixed accuracy level without running the algorithm to develop accuracy estimations. If (at block 422) the accuracy exceeds the accuracy threshold, then the specified classifier as finalized (at block 424) and indication of the specified classifier is removed from the classifier training set. If (at block 422) the accuracy threshold is not exceeded, then the specified classifier is trained (at block 426) to adjust weights and biases to output a positive classification from the input feature vector 206 with a high confidence level for training set entries 200; for the specified classifier indicating a false negative. A false negative occurs when the output classification 208 indicates no malware activity and the label 210 indicates positive. The specified classifier is further trained (at block 428) to adjust weights and biases to output a negative classification from the input feature vector 206 with a high confidence level for training set entries for the specified classifier indicating a false positive. In certain embodiments, only the malware classifiers are trained, and not benign activity classifiers.

After running the emulator for the configuration parameters for all of the malware/benign activity types and generating training entries for all the classifiers that have not yet been trained to an acceptable accuracy level, control proceeds to block 434 to determine if the classifier training set, i.e., classifiers not yet trained to an acceptable accuracy level, is empty. If (at block 434) the classifier training set is empty, then the classifiers for the malware types are deployed (at block 436) in the user system to detect malware during production operations and take protective action if malware is detected by the classifiers. Otherwise, if the classifier training set is not empty, then control returns to block 404 in FIG. 4A to run the emulator for all the malware/benign activity types to generate further training sets to train those classifiers not yet performing with acceptable accuracy.

In further embodiments, the classifiers are trained to output multi-class classifications in addition to binary classification. In such embodiments, when the emulator generates specific malware samples for a family of malware types, a single classifier could be trained to classify traces as one of a plurality of malware types to indicate the malware type in the classification, e.g., classify a trace as one of multiple types of malware or not of the malware types recognized by the classifier. Such multi-classifier classifiers would be trained to identify one of multiple types of malware.

With the embodiments of FIGS. 4A and 4B, the emulator is run to mimic all the malware/benign activity types to generate malware or benign traces to input into all of the classifiers. This allows a determination of classifiers producing false negatives and false positives at an unacceptable rate such that they need to be trained to classify the traces correctly at an acceptable rate. Further, with described embodiments, the emulator runs within the user system to allow the malware classifiers to be trained in operating conditions specific to the user system in which the classifiers will be trained. This allows for malware classifiers that are tailored toward the user operating environment and, thus, likely to be more accurate.

The present invention may be a system, a method, and/or a computer program product. The computer program product may include a computer-readable storage medium (or media) having computer-readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

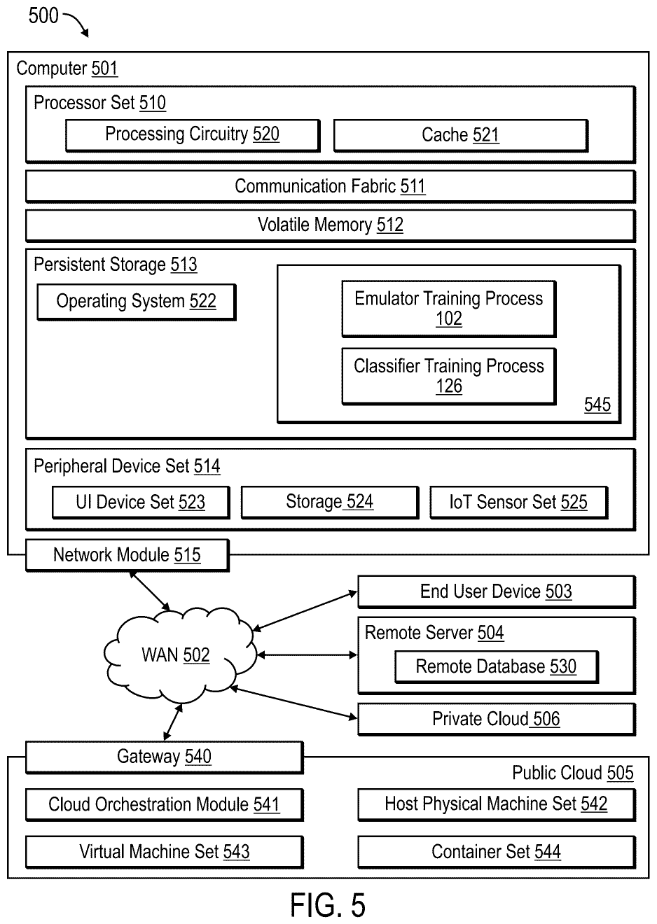

With respect to FIG. 5, computing environment 500 contains an example of an environment for the execution of at least some of the computer code involved in performing the inventive methods, such as the components of the emulator training process 102 and the classifier training process 126 described with respect to FIGS. 4A and 4B. Block 545 may include the emulator training process 102 and the classifier training process 126. In addition to block 545, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 545, as identified above), peripheral device set 514 (including user interface (UI) device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer-readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in block 545 in persistent storage 513.

COMMUNICATION FABRIC 511 is the signal conduction path that allows the various components of computer 501 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, volatile memory 512 is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface-type operating systems that employ a kernel. The code included in block 545 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer-readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN 502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

CLOUD COMPUTING SERVICES AND/OR MICROSERVICES (not separately shown in FIG. 5): private and public clouds 506 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (Saas) where software is centrally hosted and allocated on a subscription basis. SaaS is also known as on-demand software, web-based software, or web-hosted software. Four technological sub-fields involved in cloud services are: deployment, integration, on demand, and virtual private networks.

The letter designators, such as i and n, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

1. A computer implemented method for emulating malicious code, comprising:
determining whether an emulator training classifier classifies emulator training traces, resulting from operations of an emulator implementing configuration parameters, as malicious activity that exceeds a threshold rate of malicious activity;
saving the configuration parameters for a malware type in response to the malicious activity exceeding the threshold rate;
deploying an instance of the emulator to operate with the saved configuration parameters in a system to generate operations to produce classifier training traces to train a malware classifier to recognize malicious activity in the system for the malware type; and
deploying the malware classifier in the system to detect and report malicious activity during production operations in the system.

2. The computer implemented method of claim 1, wherein the system comprises a user system, and wherein the emulator and the malware classifier are deployed at the user system.

3. The computer implemented method of claim 1, wherein the emulator training traces comprise nth emulator training traces collected at an nth time, wherein the configuration parameters comprise an nth set of configuration parameters, further comprising:
determining whether the emulator training classifier classifies (n−1)th emulator training traces, resulting from operations of the emulator implementing an (n−1)th set of configuration parameters at an (n−1)th time, as malicious activity exceeding the threshold rate; and
generating the nth set of configuration parameters in response to determining that the emulator training classifier classifies (n−1)th emulator training traces as malicious activity below the threshold rate.

4. The computer implemented method of claim 1, wherein the emulator training classifier is trained using malware traces gathered from executing real malware.

5. The computer implemented method of claim 1, wherein the emulator training traces and the classifier training traces generated by the emulator are selected from the group consisting of: Shannon entropy of writes; variance of logical block address (LBA) reads and writes; read/write throughput; variance of LBA reads and writes to a master boot record; variance of LBA reads and writes to a boot partition; variance of LBA reads and writes to an operating system partition; variance of LBA reads and writes to a recovery partition; and variance of LBA reads and writes to a data partition.

6. The method of claim 1, wherein the configuration parameters used to configure the emulator are selected from the group consisting of: target directories to which the emulator reads and writes; file ordering operations to select files on which to operate; filtering options to filter files by file types on which to operate; encryption algorithm and encryption methods to use to encrypt data; encryption content methods to select a subset of content in files to encrypt; encryption write method indicating one of overwriting original file, shredding the original file and writing to a new file, and copying the original file to a new file; delay mode indicating delays between file encryption operations; timeout to specify a time limit for the encryption operations; custom file extension for encrypted files; and indicating whether to use multiple threads for emulator operations.

7. The computer implemented method of claim 1, further comprising:
generating new configuration parameters until the emulator, using the new configuration parameters, produces operations resulting in emulator training traces that are classified by the emulator training classifier as malicious activity above the threshold rate.

8. The computer implemented method of claim 1, wherein there are a plurality of emulator training classifiers and malware classifiers for a plurality of malware types, wherein the operations of determining whether the emulator training classifier classifies emulator training traces as malicious activity, saving the configuration parameters, deploying the instance of the emulator and deploying the malware classifier are performed for each of the malware types.

9. The computer implemented method of claim 1, wherein there are a plurality of emulator training classifiers and malware classifiers for a plurality of malware types, and wherein the emulator training classifiers include an emulator training classifier for a benign activity type to identify the benign activity type, and wherein the saved configuration parameters are used to control the emulator to generate operations for malware types and for a benign activity type.

10. The computer implemented method of claim 1, wherein there are configuration parameters to control the emulator to output operations for benign activity, wherein the generating operations to produce classifier training traces to train a malware classifier comprises:
generating operations from the emulator implementing the configuration parameters for the malware type and a benign activity type;
generating training entries indicating a false negative when the malware classifier outputs a negative classification from traces result from operations of the emulator implementing the configuration parameters for the benign activity type;
generating training entries indicating a false positive when the malware classifier outputs a positive classification from traces result from operations of the emulator implementing configuration parameters for the benign activity type or another malware type; and
training the malware classifier to output a positive classification from training entries indicating a false negative; and
training the malware classifier to output negative classification from training entries indicating a false positive.

11. The computer implemented method of claim 1, wherein the configuration parameters are saved for a plurality of malware types to control the emulator to generate classifier training traces for the plurality of malware types, wherein the emulator generates operations to produce classifier training traces for the plurality of malware types to train the malware classifier to recognize malicious activity for the plurality of malware types.

12. The computer implemented method of claim 1, wherein the operations resulting from the emulator emulates I/O operations generated from the group consisting of: a computational storage device; a storage device layer; an operating system layer; a block level from the operating system layer; an object/file level from a user application layer; a memory subsystem; and a network layer.

13. A computer program product for emulating malicious code, comprising:
one or more computer-readable storage media; and
program instructions stored on the one or more computer-readable storage media to perform operations comprising:
determining whether an emulator training classifier classifies emulator training traces, resulting from operations of an emulator implementing configuration parameters, as malicious activity that exceeds a threshold rate of malicious activity;
saving the configuration parameters for a malware type in response to the malicious activity exceeding the threshold rate;
deploying an instance of the emulator to operate with the saved configuration parameters in a system to generate operations to produce classifier training traces to train a malware classifier to recognize malicious activity in the system for the malware type; and
deploying the malware classifier in the system to detect and report malicious activity during production operations in the system.

14. The computer program product of claim 13, wherein the operations further comprise:
generating new configuration parameters until the emulator, using the new configuration parameters, produces operations resulting in emulator training traces that are classified by the emulator training classifier as malicious activity above the threshold rate.

15. The computer program product of claim 13, wherein there are a plurality of emulator training classifiers and malware classifiers for a plurality of malware types, wherein the operations of determining whether the emulator training classifier classifies emulator training traces as malicious activity, saving the configuration parameters, deploying the instance of the emulator and deploying the malware classifier are performed for each of the malware types.

16. The computer program product of claim 13, wherein there are configuration parameters to control the emulator to output operations for benign activity, wherein the generating operations to produce classifier training traces to train a malware classifier comprises:
generating operations from the emulator implementing the configuration parameters for the malware type and a benign activity type;
generating training entries indicating a false negative when the malware classifier outputs a negative classification from traces result from operations of the emulator implementing the configuration parameters for the benign activity type;
generating training entries indicating a false positive when the malware classifier outputs a positive classification from traces result from operations of the emulator implementing configuration parameters for the benign activity type or another malware type; and
training the malware classifier to output a positive classification from training entries indicating a false negative; and
training the malware classifier to output negative classification from training entries indicating a false positive.

17. A system for emulating malicious code, comprising:
a processor set;
one or more computer-readable storage media; and
program instructions stored on the one or more computer-readable storage media to cause the processor set to perform operations comprising:
determining whether an emulator training classifier classifies emulator training traces, resulting from operations of an emulator implementing configuration parameters, as malicious activity that exceeds a threshold rate of malicious activity;
saving the configuration parameters for a malware type in response to the malicious activity exceeding the threshold rate;
deploying an instance of the emulator to operate with the saved configuration parameters in a system to generate operations to produce classifier training traces to train a malware classifier to recognize malicious activity in the system for the malware type; and
deploying the malware classifier in the system to detect and report malicious activity during production operations in the system.

18. The system of claim 17, wherein the operations further comprise:
generating new configuration parameters until the emulator, using the new configuration parameters, produces operations resulting in emulator training traces that are classified by the emulator training classifier as malicious activity above the threshold rate.

19. The system of claim 17, wherein there are a plurality of emulator training classifiers and malware classifiers for a plurality of malware types, wherein the operations of determining whether the emulator training classifier classifies emulator training traces as malicious activity, saving the configuration parameters, deploying the instance of the emulator and deploying the malware classifier are performed for each of the malware types.

20. The system of claim 17, wherein there are configuration parameters to control the emulator to output operations for benign activity, wherein the generating operations to produce classifier training traces to train a malware classifier comprises:
generating operations from the emulator implementing the configuration parameters for the malware type and a benign activity type;
generating training entries indicating a false negative when the malware classifier outputs a negative classification from traces result from operations of the emulator implementing the configuration parameters for the benign activity type;
generating training entries indicating a false positive when the malware classifier outputs a positive classification from traces result from operations of the emulator implementing configuration parameters for the benign activity type or another malware type; and
training the malware classifier to output a positive classification from training entries indicating a false negative; and
training the malware classifier to output negative classification from training entries indicating a false positive.
